(19) United States
(12) Patent Application Publication
(10) Pub. No.: US 2025/0140448 A1
(43) Pub. Date: May 1, 2025

(54) Bi-Layer Barrier Assembly for Iron-Based Superconductor and Associated Methods

(71) Applicant: FERMI RESEARCH ALLIANCE, LLC, Batavia, IL (US)

(72) Inventor: Xingchen XU, Batavia, IL (US)

(21) Appl. No.: 18/834,077

(22) PCT Filed: Jan. 30, 2022
(86) PCT No.: PCT/US2022/014471

§ 371 Date: Jul. 29, 2024

(51) Int. Cl. H01B 12/04

(52) U.S. Cl. CPC H01B 12/04

(57) ABSTRACT

Bi-layer barrier assemblies for iron-based superconductor (IBS) and associated sheathed wire fabrication methods employ insulating material to prevent interdiffusion between inner silver (Ag) and outer matrix components at heat treatments. A superconductor assembly comprises a core IBS material (e.g., mono-filamentary or multi-filamentary IBS powder) layered, in turn, with an AG barrier material, an insulating barrier material (e.g., niobium (Nb), tantalum (Ta), and/or a Nb—Ta alloy); and a matrix material (e.g., copper (Cu), Cu alloy, and/or monel). Assembly comprises 1) packing the IBS material into the Ag sheath (barrier) material, defining a packed first assembly; 2) layering the insulating barrier material upon the Ag sheath material, defining an insulated second assembly; and 3) layering the matrix material upon the insulating material, defining a matrixed third assembly. Additional steps may comprise respective drawing of the packed first assembly, the insulated second assembly, and/or the matrixed third assembly, and/or stacking for multi-filamentary implementations.

### STATEMENT REGARDING FEDERALLY SPONSORED RESEARCH OR DEVELOPMENT

The invention described in this patent application was made with Government support under the Fermi Research Alliance, LLC, Contract Number DE-AC02-07CH11359 awarded by the U.S. Department of Energy. The Government has certain rights in the invention.

### FIELD OF THE INVENTION

The present invention relates generally to superconductor technology. More particularly, this invention pertains to assemblies and associated fabrication methods for high temperature superconductors (HTS) employed in high-field magnetic applications.

### BACKGROUND OF THE INVENTION

Superconductor materials can carry high loss-less currents and generate high magnetic fields and, therefore, are often employed for building high-field magnets. Of the superconductors that are relevant for magnet applications, low temperature superconductors (LTS), such as niobium-titanium (NbTi) and niobium-tin (Nb₃Sn), have been demonstrated in magnet designs to deliver a field range up to 16 Tesla (T) for accelerator magnets and 23 T for solenoid magnets and at acceptable costs. However, the need to achieve even higher field ranges requires use of high temperature superconductors (HTS). Common HTS materials such as bismuth strontium calcium copper oxide (BSCCO) and rare-earth barium copper oxide (ReBCO) have achieved significant improvement in critical current density (J_{c}) in recent years, but the feasibility to build high-field accelerator magnets is still to be demonstrated due to some technical issues. The costs of current BSCCO and ReBCO superconductors are also much higher than LTS.

The emerging Iron-based superconductors (IBS) may hold promise for high-field magnet applications requiring field ranges beyond what LTS may provide. This relatively new type of superconductor has relatively high critical temperature (T_{c}), high upper critical field (B_{c2}), and low anisotropy y. For example, the 122-type Ba(Sr)₁₋ₓKₓFe_{z}As₂ superconductors, which currently hold the highest γ, among all IBS, have T_{c} of up to 38 K, B_{c2} larger than 100 T, and γ<2. Furthermore, these superconductors can be fabricated into multifilamentary wires using the simple powder-in-tube (PIT) technology. Such multifilamentary wires, compared with ReBCO conductors that are mainly available in coated tapes, are a preferred form for building magnets (particularly accelerator magnets), and can have lower persistent-current magnetization (such magnetization leads to undesirable field errors and AC loss). Compared with BSCCO conductors in which a high fraction (typically >70 vol. %) is pure (or nearly pure) silver, such IBS conductors can use other matrix materials (e.g., Cu), which leads to much lower cost and higher mechanical strength.

A preferred method for fabricating IBS wires based on the PIT technology is the ex-situ method, which uses already-formed IBS powders. For certain types of IBS wires (e.g., 122-type), silver (Ag) is a preferred sheath material contacting the IBS powders because other metals can react with the IBS powders during the subsequent heat treatment. However, use of only Ag as the sheath material is undesirable because (1) Ag is expensive, leading to high conductor cost, and (2) Ag is soft, making the conductors mechanically weak. A solution is to use a matrix material (e.g., copper, iron, monel, or other high-strength alloys) outside the Ag sheath. Pure Cu is preferred for the matrix because Cu has high electrical and thermal conductivities, which is important for the electromagnetic stability of conductors. Referring to FIG. 1, schematic 100 illustrates a first exemplary IBS design known in the art that comprises a mono-filament IBS powder 110 packed in a sheath material characterized by an Ag barrier 120 positioned between the IBS powder 110 and an external matrix 130. The matrix material may be copper, iron, monel, or other high-strength alloys. Similarly, FIG. 2 presents schematic 200 of a second exemplary IBS design known in the art that comprises multi-filament IBS powder 210 respectively packed in a sheath material characterized by an Ag barrier 220 that both separates and surrounds the IBS powder filaments 210. An outer circumference of the Ag barrier 220 is established between the IBS powder filaments 210 and an external matrix 230. For example, a total radius of the IBS wires 100, 200 of FIGS. 1 and 2 may be less than two (2) millimeters (mm).

However, a problem with known IBS designs using Ag+Cu as sheath materials such as those illustrated 100, 200 in FIGS. 1 and 2 is that Cu and Ag react (or interdiffuse) during heat treatment, and even form a liquid phase above 779° C. In order to prevent, or at least reduce, this potentially destructive Cu/Ag reaction inside the IBS wires with the designs of the illustrated type 100, 200, a method that has been used is limiting the heat treatment to a low temperature (e.g., below 770° C.) and a short duration. However, this method may lead to at least two other undesirable consequences: (1) the performance of the IBS is compromised because the low heat treatment temperature may be below the optimum for enabling IBS superconductor performance; and (2) even though the low temperature may reduce Cu and Ag liquid formation, the Cu and Ag may still interdiffuse, which may be detrimental to the electromagnetic stability of the IBS.

Accordingly, a need exists for a solution to at least one of the aforementioned challenges in design and implementation of iron-based superconductors (IBS) for high-field magnet applications.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to bi-layer barrier assemblies for iron-based superconductor (IBS) and associated fabrication methods that may employ insulating material to prevent a reaction or interdiffusion between silver (Ag) and matrix components during heat treatments.

In one embodiment of the present invention, a superconductor assembly may comprise at least one IBS material (e.g., IBS powder), an Ag barrier material layered upon a respective outer surface of each filament of IBS material present, an insulating barrier material layered upon an outer surface of the Ag barrier material opposite the IBS material; and a matrix material layered upon an outer surface of the insulating barrier material opposite the Ag barrier material. The matrix material may be Cu or Cu alloy or monel. The IBS material may be of a mono-filamentary type or a multi-filamentary type. The insulating barrier material may comprise one or more of niobium (Nb), tantalum (Ta), and a Nb—Ta alloy. Such a barrier material may be ductile enough so that the assembly can be drawn/extruded/swaged/rolled from a big billet to wires/tapes with much smaller cross sections. The IBS material, the Ag barrier material, the insulating barrier material, and the matrix material may be configured as a sheathed wire having a fixed and substantially uniform cross-sectional profile such that the insulating material may be configured to prevent a reaction or interdiffusion between the Ag sheath material and the matrix material during heat treatments.

In a method aspect of the present invention, fabrication of bi-layer barrier assemblies for iron-based superconductor (IBS) according to certain embodiments of the present invention may comprise the steps of 1) packing at least one IBS material into an Ag sheath material, to define a packed first assembly; 2) layering an insulating material comprising at least one of Nb, Ta, and Nb—Ta alloy upon the Ag sheath material opposite the at least one IBS material, to define an insulated second assembly; and 3) layering a matrix material upon the insulating material opposite the Ag sheath material, to define a matrixed third assembly. The IBS material may be one of a mono-filamentary type and a multi-filamentary type and characterized by a (mono- or multi-) core radius less than one (1) mm. Similarly, each of the Ag sheath material, the insulating material, and the matrix material may be characterized by a respective thickness less than one (1) mm. Certain method aspects of the present invention may further comprise a respective extrusion/drawing/swaging/rolling step for one or more of the packed first assembly, the insulated second assembly, and/or the matrixed third assembly.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is a cross-section view of an exemplary mono-filamentary IBS assembly according to the prior art;

FIG. 2 is a cross-section view of an exemplary multi-filamentary IBS assembly according to the prior art;

FIG. 3 is a cutaway, perspective top view of a bi-layer barrier IBS assembly according to an embodiment of the invention;

FIG. 4 is a cross-section view of the bi-layer barrier IBS assembly of FIG. 3 taken through line A-A; and

FIG. 5 is a flow chart of method steps for fabricating a mono-filamentary bi-layer barrier IBS assembly according to an embodiment of the invention.

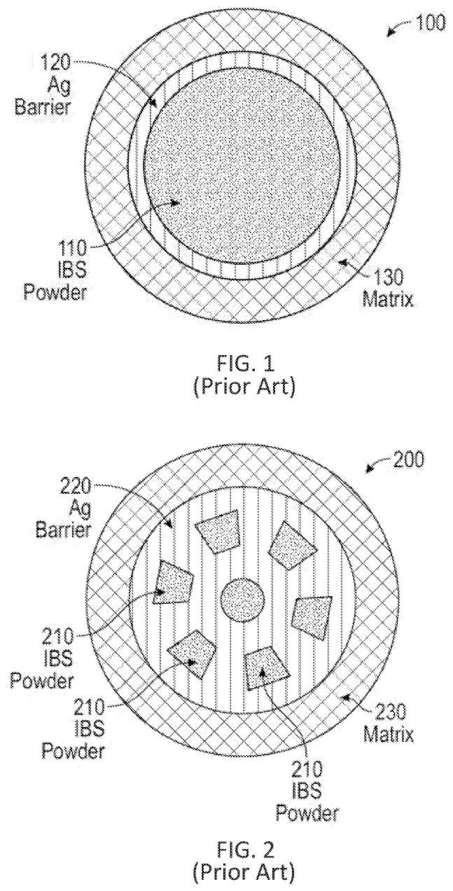

Like reference numerals refer to like parts throughout the several views of the drawings.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

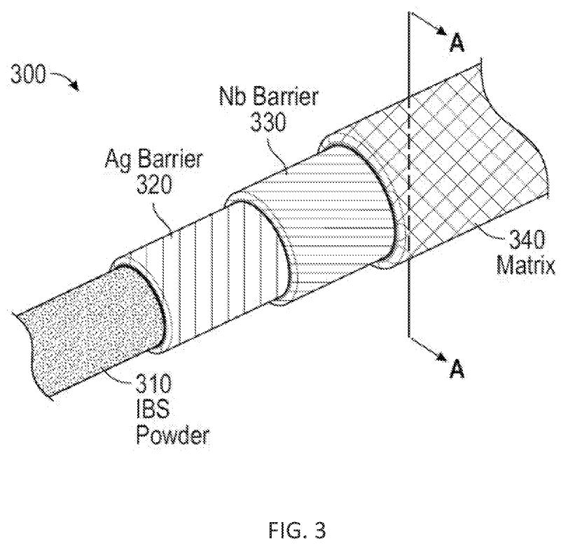

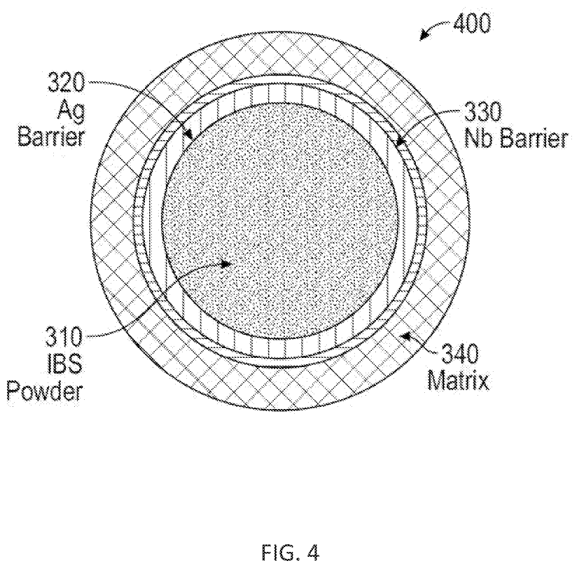

Referring initially to FIGS. 3 and 4, a bi-layer barrier IBS assembly according to an embodiment of the present invention is now described in detail. Throughout this disclosure, the present invention may be referred to as a bi-layer barrier assembly, an IBS assembly, an IBS, a bi-layer superconductor tape, a bi-layer superconductor wire, a bi-layer superconductor, a superconductor, an assembly, a tape, a wire, and/or a method for bi-layer barrier IBS fabrication. Embodiments of the invention may include systems and methods, including mathematical methods differing in specific detail from the ones illustrated in the figures and examples below, but nonetheless delivering the same HTS functionality for high-field magnet applications. Those skilled in the art will appreciate that this terminology is only illustrative and does not affect the scope of the invention.

Referring more specifically to FIGS. 3 and 4, an embodiment 300, 400 of the present invention may be characterized as an IBS PIT design that may comprise an IBS powder 310 that may be fittedly packed within a substantially cylindrical and/or tubular silver (Ag) sheath 320 (also referred to as a silver reaction barrier or an Ag barrier). Although the illustrated IBS PIT design 300, 400 is characterized by the IBS powder 310 in monofilament form, a person of skill in the art will immediately recognize multi-filamentary IBS wires and/or tapes may be employed without departing from the scope of the invention. Between the Ag barrier 320 and an outermost matrix 340, a barrier 330 may be positioned to act as an insulator (more specifically, a reaction suppressor) between the Ag barrier 320 and the matrix 340. For example, and without limitation, the barrier 330 (also referred to herein as an insulating barrier or insulating layer) may comprise a material such as niobium (Nb), tantalum (Ta), or some Nb—Ta alloy. By separating the Ag barrier 320 and the matrix 340 using the insulating barrier 330 of Nb, Ta, or other metals or alloys that react with neither Ag nor the matrix material (e.g., Cu), the present invention may advantageously prevent Ag/matrix reaction and thereby enable use of the optimal heat treatment to improve IBS performance and also to prevent degradation of thermal conductivity. Embodiments of the present invention may be characterized by working sizes/dimensions similar to those of various IBS PIT designs known in the art, as described hereinabove.

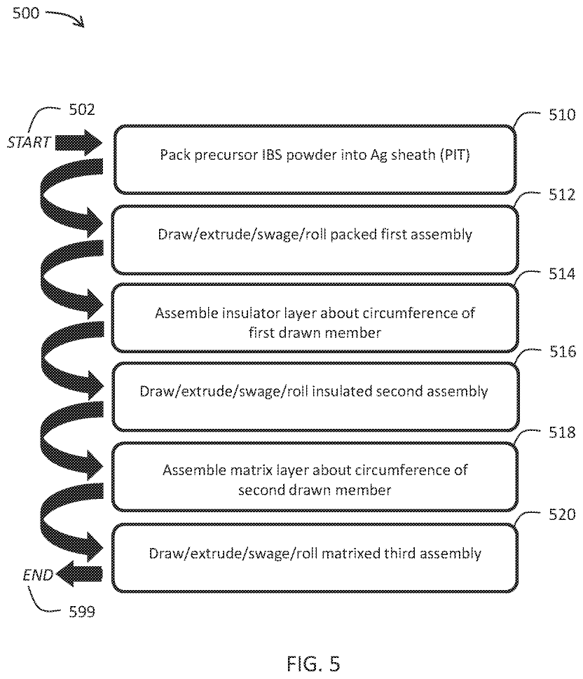

Referring now to FIG. 5, and continuing to refer to FIGS. 3 and 4, a method of fabrication 500 for a bi-layer barrier IBS assembly 300 according to an embodiment of the present invention is now described in detail. From the start at Block 502, a PIT step may comprise packing (Block 510) a precursor IBS powder 310 in a silver (Ag) sheath 320 to create a packed first assembly that, for example, and without limitation, may be extruded/swaged/rolled/drawn through an extruder/swager/roller/drawing machine (Block 512) to create an object (i.e., first drawn assembly) of fixed and substantially uniform cross-sectional profile (e.g., a sheathed wire). At Block 514, an insulator material (e.g., Nb barrier 330) may be assembled (e.g., layered) about a circumference of the first drawn assembly to insulated second create an assembly that may be drawn/extruded/swaged/rolled (Block 516) to create a second drawn assembly having the insulator layer 330 in the wire under fabrication. At Block 518, a matrix material (e.g., matrix 340) may be assembled (e.g., layered) about a circumference of the second drawn assembly to create a matrixed third assembly that may be drawn/extruded/swaged/rolled (Block 520) to create a bi-layer barrier IBS monofilament 300 according to an embodiment of the present invention, at which point the method 500 may end (Block 599). Although FIG. 5 illustrates steps for fabricating a mono-filamentary bi-layer barrier IBS wire, any of the mentioned assemblies may be stacked to create an assembly that may be drawn/extruded/swaged/rolled to create a multi-filamentary IBS wire. For example, and without limitation, the multi-filamentary wire may be directly wound into coils, rolled to flat tapes, or cold/hot pressed to different shapes, and finally heat treated with or without pressure.

A person of skill in the art will immediately recognize that the various assembly and drawing/extrusion/swaging/rolling steps described hereinabove may be accomplished in alternative order (e.g., complete assembly steps such as those at Blocks 514 and 518, in turn, followed by a single drawing/extrusion/swaging/rolling step such as Block 520 to make the assembled materials 310, 320, 330, 340 into an IBS wire 300) without departing from the scope of the invention. Furthermore, additional fabrication steps to address specific handling requirements due to respective properties of Nb, Ta, and/or other metals or malleable alloys that react with neither Ag nor the matrix material may complement the method described hereinabove without departing from the scope of the invention.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced items.

Thus, the scope of the invention should be determined by the appended claims and their legal equivalents, and not by the examples given.

That which is claimed is:

1. A superconductor assembly comprising:
at least one iron-based superconductor (IBS) material [310];
a silver (Ag) barrier material layered upon a respective first outer surface of each of the at least one IBS material [310];
an insulating barrier material layered upon a second outer surface of the Ag barrier material opposite the at least one IBS material [310]; and
a matrix material layered upon a third outer surface of the insulating barrier material opposite the Ag barrier material [320].

2. The superconductor assembly according to claim 1, wherein the at least one IBS material is of one of a mono-filamentary type and a multi-filamentary type [200].

3. The superconductor assembly according to claim 1, wherein the insulating barrier material comprises at least one of niobium (Nb), tantalum (Ta), and a Nb—Ta alloy.

4. The superconductor assembly according to claim 1, wherein the matrix material comprises at least one of copper (Cu), Cu alloy, or monel.

5. A method of superconductor fabrication comprising the steps of:
applying a silver (Ag) sheath material to a respective first circumference of each of at least one iron-based superconductor (IBS) material [310], to define a packed first assembly [510];
applying an insulating material to a second circumference of the Ag sheath material opposite the at least one IBS material [310], to define an insulated second assembly [514]; and
applying a matrix material to a third circumference of the insulating material opposite the Ag sheath material [320], to define a matrixed third assembly [518].

6. The method according to claim 5, wherein the at least one IBS material is of one of a mono-filamentary type and a multi-filamentary type [200].

7. The method according to claim 5, wherein the insulating material comprises one of niobium (Nb) and tantalum (Ta).

8. The method according to claim 5, where the applying the Ag sheath further comprises the step of:
packing the at least one iron-based superconductor (IBS) material into the Ag sheath material [320].

9. The method according to claim 5, where the applying the insulating material further comprises the step of:
drawing the insulating material onto the second circumference of the Ag sheath material [320].

10. The method according to claim 5, where the applying the matrix material further comprises the step of:
drawing the matrix material onto the third circumference of the insulating material [330].

11. A method of superconductor fabrication comprising the steps of:
packing at least one iron-based superconductor (IBS) material into a silver (Ag) sheath material [320], to define a packed first assembly [510];
layering an insulating material comprising at least one of niobium (Nb), tantalum (Ta), and Nb—Ta alloy upon the Ag sheath material opposite the at least one IBS material [310], to define an insulated second assembly [514]; and
layering a matrix material upon the insulating material opposite the Ag sheath material [320], to define a matrixed third assembly [518].

12. The method according to claim 11, wherein the at least one IBS material is of one of a mono-filamentary type and a multi-filamentary type [200].

13. The method according to claim 12, wherein the at least one IBS material is of a mono-filamentary type and is characterized by a core radius less than one (1) millimeter (mm).

14. The method according to claim 11, wherein the Ag sheath material is characterized by a first-layer thickness less than one (1) millimeter (mm).

15. The method according to claim 11, wherein the insulating material is characterized by a second-layer thickness less than one (1) millimeter (mm).

16. The method according to claim 11, wherein the matrix material is characterized by a third-layer thickness less than one (1) millimeter (mm).

17. The method according to claim 11, further comprising the step of drawing the packed first assembly [510].

18. The method according to claim 11, further comprising the step of drawing the insulated second assembly [514].

19. The method according to claim 11, further comprising the step of drawing the matrixed third assembly [518].

20. The method according to claim 11, further comprising the step of preventing, using the insulating material of the matrixed third assembly at a heat treatment, an interdiffusion between the Ag sheath material and the matrix material [340].
